(19) United States
(12) Patent Application Publication
(10) Pub. No.: US 2026/0084409 A1
(43) Pub. Date: Mar. 26, 2026

(54) LIQUID DISCHARGE APPARATUS

(71) Applicant: SEIKO EPSON CORPORATION, Tokyo (JP)

(72) Inventors: Harunobu KOIKE, MATSUMOTO-SHI (JP); Takashi AOKI, SHIOJIRI-SHI (JP)

(21) Appl. No.: 19/335,228

(22) Filed: Sep. 22, 2025

(30) Foreign Application Priority Data
Sep. 24, 2024 (JP) 2024-165056

(51) Int. Cl. B41J 2/045; B41J 2/14

(52) U.S. Cl. CPC B41J 2/04508; B41J 2/0457; B41J 2/04581; B41J 2/04588; B41J 2/14233; B41J 2002/14419; B41J 2002/14491

(57) ABSTRACT

A liquid discharge apparatus including a pressure chamber substrate provided with a pressure chamber communicating with a nozzle through which a liquid is discharged, a diaphragm provided on the pressure chamber substrate, a piezoelectric element provided on the diaphragm and having a piezoelectric layer interposed between two electrodes, and a control section that controls driving of the piezoelectric element, the piezoelectric element being driven by the control section to apply a pressure to liquid in the pressure chamber to discharge the liquid through the nozzle, a compliance value of the piezoelectric element at a minimum voltage which is applied to the piezoelectric element is smaller than a compliance value of the piezoelectric element at a maximum voltage which is applied to the piezoelectric element.

The present application is based on, and claims priority from JP Application Serial Number 2024-165056, filed Sep. 24, 2024, the disclosure of which is hereby incorporated by reference herein in its entirety.

### BACKGROUND

### 1. Technical Field

The present disclosure relates to a liquid discharge apparatus including a piezoelectric element, and particularly to an ink jet recording apparatus that discharges ink as a liquid.

### 2. Related Art

As a liquid discharge apparatus that ejects a liquid to a target medium, an ink jet recording apparatus that discharges ink as a liquid and performs printing on a target medium (recording medium) such as paper or a recording sheet is known.

An ink jet recording head that is mounted on the ink jet recording apparatus includes a diaphragm that defines a pressure chamber on one surface side of a pressure chamber substrate on which the pressure chamber communicating with a nozzle is formed, and a piezoelectric element provided on the diaphragm, and the piezoelectric element is driven by a drive signal to impart a pressure change to ink in the pressure chamber and discharge the ink from the nozzle. JP-A-2020-29038 is an example of the related art.

In the related art, it is considered that the higher the drive voltage to be applied to a piezoelectric element, the smaller the natural vibration period of the pressure chamber or the compliance of the piezoelectric element depending on the natural vibration period. In recent years, there is a demand for a piezoelectric element that can perform high-frequency driving from the viewpoint of improving productivity. For the piezoelectric element that performs high-frequency driving, since the relationship between the applied drive voltage and each parameter relating to the high-frequency driving is different, it is necessary to review the relationship between the applied drive voltage and each parameter.

### SUMMARY

According to an aspect of the present disclosure, there is provided a liquid discharge apparatus including a pressure chamber substrate provided with a pressure chamber communicating with a nozzle through which liquid is discharged, a diaphragm provided on the pressure chamber substrate, a piezoelectric element provided on the diaphragm and having a piezoelectric layer interposed between two electrodes, and a control section that controls driving of the piezoelectric element, the piezoelectric element being driven by the control section to apply a pressure to liquid in the pressure chamber to discharge the liquid through the nozzle, a compliance value of the piezoelectric element at a minimum voltage which is applied to the piezoelectric element is smaller than a compliance value of the piezoelectric element at a maximum voltage which is applied to the piezoelectric element.

In addition, according to another aspect of the present disclosure, there is provided a liquid discharge apparatus including a pressure chamber substrate provided with a pressure chamber communicating with a nozzle through which liquid is discharged, a diaphragm provided on the pressure chamber substrate, a piezoelectric element provided on the diaphragm and having a piezoelectric layer interposed between two electrodes, and a control section that controls driving of the piezoelectric element, the piezoelectric element being driven by the control section to apply a pressure to liquid in the pressure chamber to discharge the liquid through the nozzle, a natural vibration period of the pressure chamber at a minimum voltage which is applied to the piezoelectric element is smaller than a natural vibration period of the pressure chamber at a maximum voltage which is applied to the piezoelectric element.

In addition, according to still another aspect of the present disclosure, there is provided a liquid discharge apparatus including a pressure chamber substrate provided with a pressure chamber communicating with a nozzle through which liquid is discharged, a diaphragm provided on the pressure chamber substrate, a piezoelectric element provided on the diaphragm and having a piezoelectric layer interposed between two electrodes, and a control section that controls driving of the piezoelectric element, the piezoelectric element being driven by the control section to apply a pressure to liquid in the pressure chamber to discharge the liquid through the nozzle, a resonance frequency of the piezoelectric element at a minimum voltage which is applied to the piezoelectric element is larger than a resonance frequency of the piezoelectric element at a maximum voltage which is applied to the piezoelectric element.

### BRIEF DESCRIPTION OF THE DRAWINGS

FIG. 1 is a view showing a schematic configuration of a liquid discharge apparatus according to Embodiment 1.

FIG. 2 is an exploded perspective view of a liquid discharge head according to Embodiment 1.

FIG. 3 is a plan view of the liquid discharge head according to Embodiment 1.

FIG. 4 is a cross-sectional view of the liquid discharge head according to Embodiment 1.

FIG. 5 is a cross-sectional view of the liquid discharge head according to Embodiment 1.

FIG. 6 is a schematic view showing a driving state of the liquid discharge head according to Embodiment 1.

FIG. 7 is a block diagram showing an electrical configuration of the liquid discharge apparatus according to Embodiment 1.

FIG. 8 is a waveform view showing a drive signal according to Embodiment 1.

FIG. 9 is a graph showing a compliance (natural vibration period)-voltage curve.

FIG. 10 is a graph showing a compliance (natural vibration period)-voltage curve.

FIG. 11 is a graph showing a resonance frequency-voltage curve.

FIG. 12 is a graph showing a resonance frequency-voltage curve.

FIG. 13 is a table showing results of examples and comparative examples.

### DESCRIPTION OF EMBODIMENTS

The present disclosure will be described in detail below based on embodiments. However, the following description shows one aspect of the present disclosure, and can be modified as desired within the scope of the present disclosure. In each drawing, the same reference numerals indicate the same members, and the description thereof will be omitted as appropriate. In each drawing, X, Y, and Z represent three spatial axes that are orthogonal to each other. In the present specification, the directions along these axes are referred to as an X direction, a Y direction, and a Z direction. In each drawing, a direction indicated by the arrow is a positive (+) direction, and a direction opposite to the arrow is a negative (−) direction. The Z direction indicates a vertical direction, the +Z direction indicates a vertically downward direction, and the −Z direction indicates a vertically upward direction. Furthermore, the directions of three spatial axes that do not limit the positive direction and the negative direction will be described as the X-axis direction, the Y-axis direction, and the Z-axis direction.

### Embodiment 1

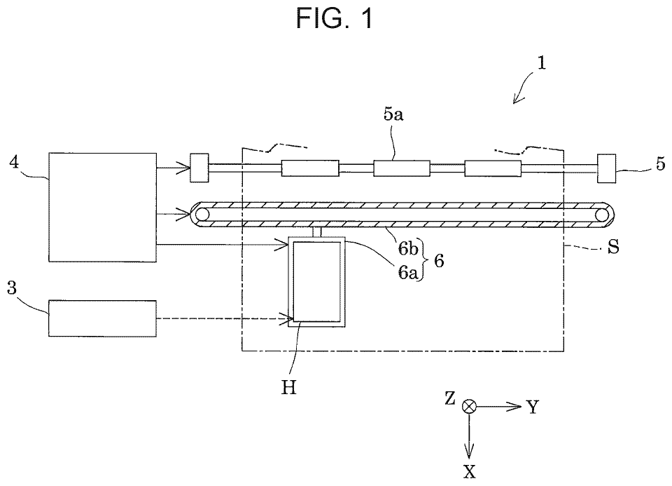

FIG. 1 is a view showing a schematic configuration of a liquid discharge apparatus according to Embodiment 1 of the present disclosure.

As shown in FIG. 1, a liquid discharge apparatus 1 is a so-called serial printer that includes a liquid discharge head H and transports the medium S in the X-axis direction, reciprocates the liquid discharge head H in the Y-axis direction, and performs printing by discharging a liquid from the liquid discharge head H toward a medium S in the +Z direction. As the medium S, any material such as recording paper or a resin film can be used in addition to cloth. In addition, a direction in which the liquid discharge head H reciprocates is not limited to the Y-axis direction, and may be a direction inclined with respect to both the X-axis direction and the Y-axis direction. In addition, in the present embodiment, the +Z direction is an example of the “discharge direction”.

The liquid discharge apparatus 1 includes the liquid discharge head H, a liquid storage portion 3, a control section 4, a transport mechanism 5 that sends out the medium S, and a moving mechanism 6.

The liquid discharge head H discharges a liquid supplied from the liquid storage portion 3 that stores the liquid as droplets in the +Z direction.

The liquid storage portion 3 individually stores a plurality of types of liquids having different colors and components that are discharged from the liquid discharge head H. Examples of the liquid storage portion 3 include a cartridge that is attachable to and detachable from the liquid discharge apparatus 1, a bag-shaped ink pack made of a flexible film, and an ink tank that can be replenished with ink. FIG. 1 shows one liquid storage portion 3 as an example. That is, the liquid storage portion 3 may be a liquid storage portion 3 having divided rooms for individually storing a plurality of types of liquids, or may be a plurality of liquid storage portions 3 individually provided according to a plurality of types of liquids. In addition, the liquid storage portion 3 may be divided into a main tank and a sub tank. The sub tank may be coupled to the liquid discharge head H, and the liquid consumed by discharging the droplets from the liquid discharge head H may be replenished from the main tank to the sub tank.

The control section 4 comprehensively controls each element of the liquid discharge apparatus 1, that is, the liquid discharge head H, the transport mechanism 5, the moving mechanism 6, and the like.

The transport mechanism 5 transports the medium S in the X-axis direction, and has transport rollers 5a. The transport mechanism 5 transports the medium S in the X-axis direction by rotating the transport rollers 5a. The transport rollers 5a are rotated by the drive of a transport motor not shown. The control section 4 controls the transport of the medium S by controlling the drive of the transport motor. The transport mechanism 5 that transports the medium S is not limited to one including the transport rollers 5a, and may be one that transports the medium S with, for example, a belt or a drum.

The moving mechanism 6 is a mechanism for reciprocating the liquid discharge head H in the Y-axis direction, and includes a holding body 6a and a transport belt 6b. The holding body 6a is a so-called carriage that holds the liquid discharge head H, and is fixed to the transport belt 6b. The transport belt 6b is an endless belt erected along the Y-axis direction. The transport belt 6b is rotated by the drive of a transport motor not shown. The control section 4 rotates the transport belt 6b by controlling the drive of the transport motor to reciprocate the liquid discharge head H in the Y-axis direction together with the holding body 6a. The holding body 6a may be configured to mount the liquid storage portion 3 together with the liquid discharge head H.

The liquid discharge head H executes a discharge operation of discharging the liquid supplied from the liquid storage portion 3 as droplets in the +Z direction from each of a plurality of nozzles 21 based on the control of the control section 4. The discharge operation by the liquid discharge head H is performed in parallel with the transport of the medium S by the transport mechanism 5 or the reciprocating movement of the liquid discharge head H by the moving mechanism 6, whereby so-called printing in which the liquid is applied to the medium S is performed.

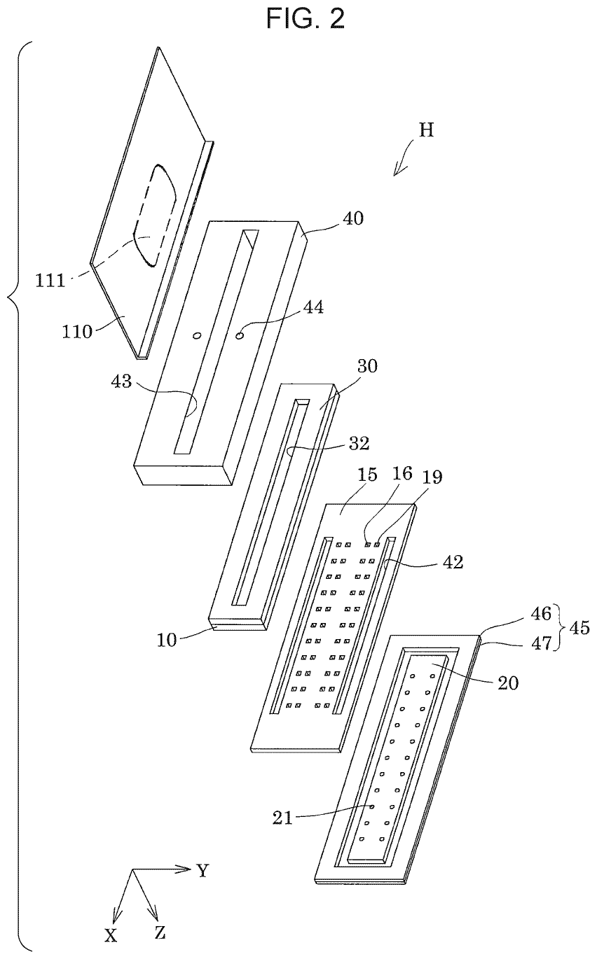

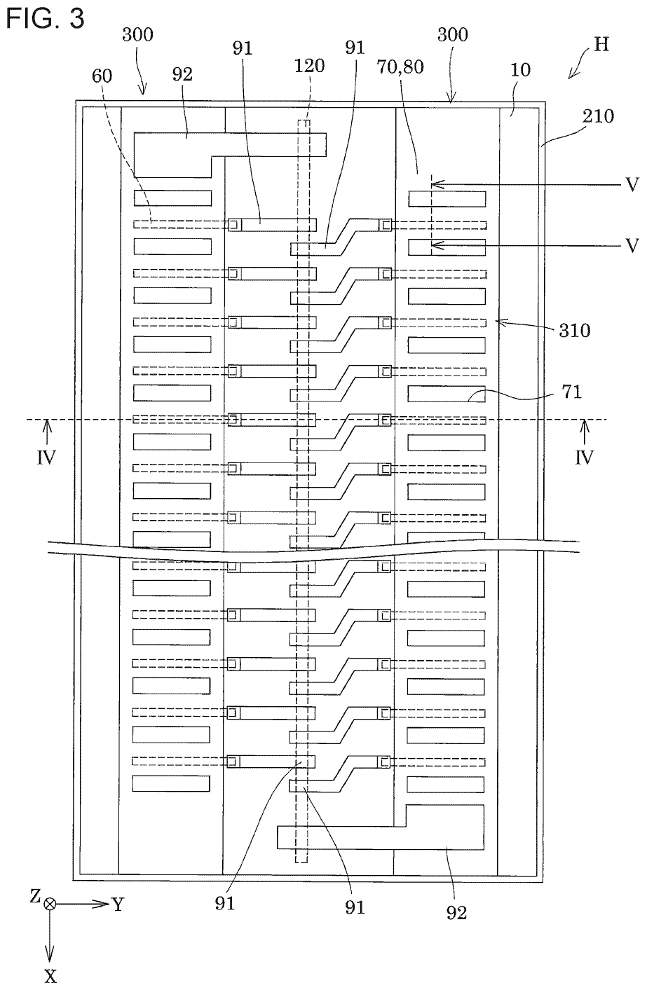

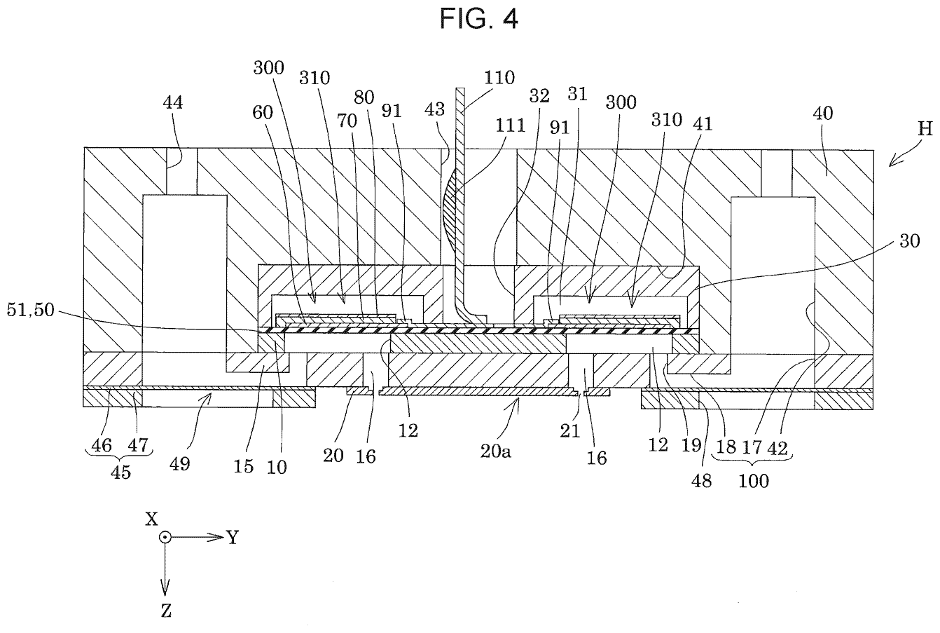

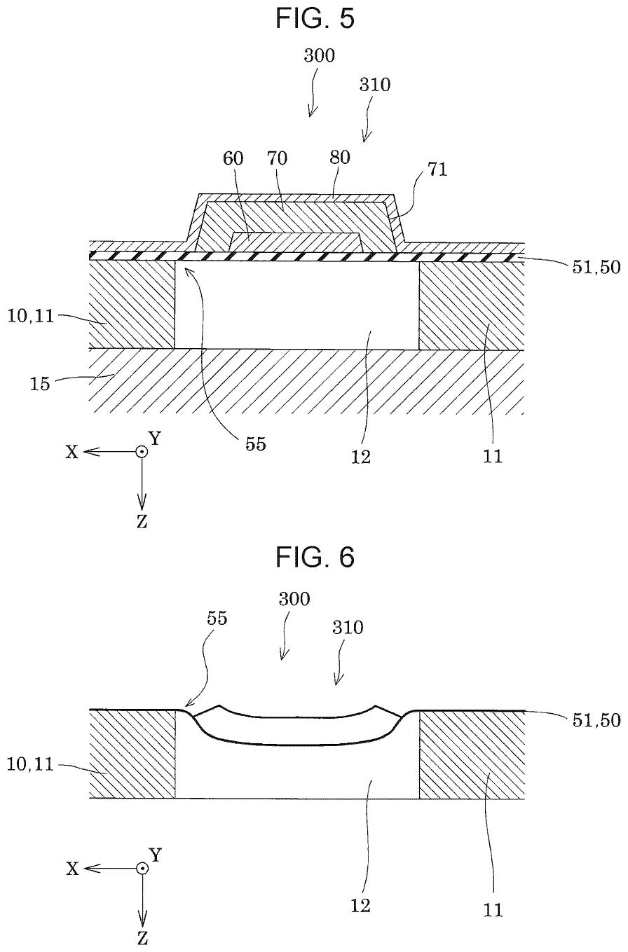

FIG. 2 is an exploded perspective view of the liquid discharge head H according to Embodiment 1 of the present disclosure. FIG. 3 is a plan view of a pressure chamber substrate 10 of the liquid discharge head H when viewed in the +Z direction. FIG. 4 is a cross-sectional view of the liquid discharge head H taken along a line IV-IV in FIG. 3. FIG. 5 is a cross-sectional view of the liquid discharge head H taken along a line V-V in FIG. 3. Each direction of the liquid discharge head H will be described based on directions when the liquid discharge head H is mounted in the liquid discharge apparatus 1, that is, the X-axis direction, the Y-axis direction, and the Z-axis direction.

As shown in the drawings, the liquid discharge head H of the present embodiment includes the pressure chamber substrate 10, a communication plate 15, a nozzle plate 20 having the plurality of nozzles 21 formed therein, a protective substrate 30, a case member 40, a piezoelectric actuator 300, and a wiring member 110.

The pressure chamber substrate 10 is formed of, for example, a silicon substrate, a glass substrate, an SOI substrate, or various ceramic substrates. In the pressure chamber substrate 10, a plurality of pressure chambers 12 are arranged side by side along the X-axis direction. The plurality of pressure chambers 12 are disposed on a straight line along the X-axis direction such that the positions thereof become the same in the Y-axis direction. Two pressure chambers 12 adjacent to each other in the X-axis direction are partitioned by a partition wall 11. In the present embodiment, the number of pressure chamber rows in which the pressure chambers 12 are arranged side by side along the X-axis direction is two in the Y-axis direction. It is needless to say that the disposition of the pressure chambers 12 is not particularly limited thereto, and the plurality of pressure chambers 12 may be disposed, for example, in a staggered manner along the X-axis direction. Here, the fact that the pressure chambers 12 are disposed in a staggered manner along the X-axis direction means that the pressure chambers 12 arranged side by side in the X-axis direction are disposed to be alternately shifted in the Y-axis direction. That is, the number of the pressure chamber rows in which the pressure chambers 12 are arranged side by side along the X-axis direction is two in the Y-axis direction, and the two pressure chamber rows are disposed to be shifted from each other by half the pitch of the pressure chambers 12, that is, so-called half pitch, in the X-axis direction.

The communication plate 15 and the nozzle plate 20 are sequentially stacked in the +Z direction on the surface of the pressure chamber substrate 10 facing the +Z direction. A diaphragm 50 and the piezoelectric actuator 300 are sequentially stacked in the −Z direction on the surface of the pressure chamber substrate 10 facing the −Z direction.

The communication plate 15 is made of a plate-shaped member bonded to the surface of the pressure chamber substrate 10 facing the +Z direction. The communication plate 15 is provided with nozzle communication passages 16 that make the pressure chambers 12 and the nozzles 21 communicate with each other. The communication plate 15 is provided with a first manifold portion 17 and a second manifold portion 18 that configure a part of a manifold 100 serving as a common liquid chamber with which the plurality of pressure chambers 12 commonly communicate. The first manifold portion 17 is provided to penetrate the communication plate 15 in the Z-axis direction. In addition, the second manifold portion 18 is provided to be open on the surface facing the +Z direction without penetrating the communication plate 15 in the Z-axis direction. Furthermore, the communication plate 15 is provided with a supply communication passage 19 that communicates with one end portion of the pressure chamber 12 in the Y-axis direction, independently for each pressure chamber 12. The supply communication passage 19 communicates between the second manifold portion 18 and the pressure chamber 12 to supply the ink in the manifold 100 to the pressure chamber 12. That is, the liquid discharge head H of the present embodiment includes the supply communication passages 19, the pressure chambers 12, and the nozzle communication passages 16 as the individual flow paths communicating with the nozzles 21. As such a communication plate 15, a silicon substrate or an SOI substrate is preferably used. The material of the communication plate 15 is not limited thereto, and a glass substrate, various ceramic substrates, a metal substrate such as a stainless substrate, or the like may be used.

The nozzle plate 20 is a plate-shaped member bonded to the surface of the communication plate 15 facing the +Z direction, that is, the surface facing the opposite side to the pressure chamber substrate 10. The nozzle plate 20 has the plurality of nozzles 21 formed therein, which communicate with each of the pressure chambers 12 through the nozzle communication passage 16. In the present embodiment, the plurality of nozzles 21 are arranged side by side in a row along the X-axis direction. In the present embodiment, two nozzle rows, in which the nozzles 21 are arranged side by side along the X-axis direction, are provided spaced apart in the Y-axis direction. As such a nozzle plate 20, a silicon substrate or an SOI substrate is preferably used. The material of the nozzle plate 20 is not limited thereto, and a glass substrate, various ceramic substrates, a metal substrate such as a stainless substrate, an organic substance such as a polyimide resin, or the like may be used.

The diaphragm 50 is made of, for example, only an elastic film 51 made of silicon oxide provided on the pressure chamber substrate 10 side. As described above, the diaphragm 50 is made of only the elastic film 51 made of silicon oxide, whereby the internal stress is a compressive stress.

The piezoelectric actuator 300 includes a first electrode 60, a piezoelectric layer 70, and a second electrode 80 that are sequentially stacked on the diaphragm 50 in the −Z direction. Such a piezoelectric actuator 300 is also called a piezoelectric element, and refers to a portion including the first electrode 60, the piezoelectric layer 70, and the second electrode 80. In addition, a portion where piezoelectric distortion occurs in the piezoelectric layer 70 when a voltage is applied between the first electrode 60 and the second electrode 80 is referred to as an active portion 310. In contrast, a portion where piezoelectric distortion does not occur in the piezoelectric layer 70 is referred to as a non-active portion. That is, the active portion 310 refers to a portion where the piezoelectric layer 70 is interposed between the first electrode 60 and the second electrode 80. In the present embodiment, the active portion 310 is formed for each pressure chamber 12. That is, a plurality of the active portions 310 are arranged side by side in the X-axis direction in the piezoelectric actuator 300. The plurality of active portions 310 serve as drive elements that cause a pressure change in the ink in the pressure chambers 12. In general, any one electrode in the active portion 310 is used as an individual electrode that is independent for each active portion 310, and the other electrode is configured as a common electrode that is common to the plurality of active portions 310. In the present embodiment, the first electrode 60 configures an individual electrode, and the second electrode 80 configures a common electrode. It is needless to say that the first electrode 60 may configure a common electrode, and the second electrode 80 may configure an individual electrode. In addition, in the piezoelectric actuator 300, a portion facing the pressure chamber 12 in the Z-axis direction is a flexible portion, and an outer portion not facing the pressure chamber 12 in the Z-axis direction is a non-flexible portion.

The first electrode 60 is divided for each of the pressure chambers 12 to configure an individual electrode independent for each of the active portions 310.

The piezoelectric layer 70 is continuously provided in the X-axis direction to have a predetermined width in the Y-axis direction. The width of the piezoelectric layer 70 is longer than the length of the pressure chamber 12 in the Y-axis direction. Therefore, the piezoelectric layer 70 extends up to the outsides of a region facing the pressure chamber 12 on both sides of the pressure chamber 12 in the +Y direction and the −Y direction. In addition, a recessed portion 71 corresponding to each partition wall 11 is formed in the piezoelectric layer 70. The width of the recessed portion 71 in the X-axis direction is the same as or wider than the width of the partition wall 11. In the present embodiment, the width of the recessed portion 71 in the X-axis direction is wider than the width of the partition wall 11. As a result, the rigidity of the portions of the diaphragm 50 facing both end portions of the pressure chamber 12 in the X-axis direction, so-called arm portions, of the diaphragm 50 is suppressed, and the piezoelectric actuator 300 can be thus significantly displaced by a small voltage, that is, the so-called displacement efficiency can be improved. The recessed portion 71 may be provided to penetrate the piezoelectric layer 70 in the Z-axis direction, which is the thickness direction, or may be provided up to the middle in the thickness direction without penetrating the piezoelectric layer 70 in the Z-axis direction. That is, on the bottom surface of the recessed portion 71 in the +Z direction, the piezoelectric layer 70 may be completely removed, or a part of the piezoelectric layer 70 may remain.

Such a piezoelectric layer 70 is configured using a piezoelectric material made of a perovskite structure composite oxide represented by a general formula ABO₃. In the present embodiment, lead zirconate titanate (PZT; Pb(Zr, Ti)O₃) is used as the piezoelectric material. When PZT is used as the piezoelectric material, the piezoelectric layer 70 having a relatively large piezoelectric constant d31 can be obtained. The piezoelectric material used for the piezoelectric layer 70 may be a material in which the content of Pb is suppressed, so-called low lead-based material, or a material in which Pb is not used, so-called lead-free material. Examples of the lead-free material include bismuth ferrite (BFO; BiFeO₃), barium titanate (BT; BaTiO₃), and potassium sodium niobate (KNN; (K, Na)(NbO₃)).

The second electrode 80 is provided on the surface side of the piezoelectric layer 70 facing the −Z direction, and configures a common electrode common to the plurality of active portions 310. The second electrode 80 is provided over a surface along an XY plane defined by the X axis and the Y axis of the surface of the piezoelectric layer 70 facing the −Z direction, a side surface, that is, a surface intersecting the above-described XY plane, of the piezoelectric layer 70, and the diaphragm 50 not covered with the piezoelectric layer 70. In addition, the second electrode 80 of the present embodiment is also provided on the side surface of the recessed portion 71 of the piezoelectric layer 70 and on the diaphragm 50 which is the bottom surface of the recessed portion 71. It is needless to say that the second electrode 80 may be provided only on a part of the inner surface of the recessed portion 71, or may not be provided over the entire inner surface of the recessed portion 71.

In addition, an individual lead electrode 91, which is a lead wiring of the present embodiment, and a common lead electrode 92 are coupled to the first electrode 60 and the second electrode 80 of the piezoelectric actuator 300, respectively.

The wiring member 110 made of a flexible substrate having flexibility is coupled to an end portion of the individual lead electrode 91 and an end portion of the common lead electrode 92 on a side opposite to end portions thereof coupled to the piezoelectric actuator 300. The wiring member 110 is mounted with a drive circuit 111 having a plurality of switching elements that select whether or not to supply a drive signal for driving each of the active portions 310 to each of the active portions 310. In other words, the wiring member 110 in the present embodiment is a chip-on-film (COF). The wiring member 110 may not be provided with the drive circuit 111. In other words, the wiring member 110 may be a flexible flat cable (FFC), a flexible printed circuit (FPC), or the like.

The protective substrate 30 having substantially the same size as the pressure chamber substrate 10 is bonded to the surface of the pressure chamber substrate 10 facing the −Z direction. The protective substrate 30 has accommodation portions 31 which are spaces for protecting the piezoelectric actuator 300. Two accommodation portions 31 are provided independently for each row of the active portions 310 arranged side by side in the X-axis direction, and are arranged side by side in the Y-axis direction. In addition, the protective substrate 30 has a through-hole 32 penetrating the protective substrate 30 in the Z-axis direction between the two accommodation portions 31 arranged side by side in the Y-axis direction. The end portions of the individual lead electrode 91 and the common lead electrode 92 drawn out from the electrodes of the piezoelectric actuator 300 are extended to be exposed in the through-hole 32, and the individual lead electrode 91 and the common lead electrode 92 are electrically coupled to the wiring member 110 in the through-hole 32. As such a protective substrate 30, a silicon substrate or an SOI substrate is preferably used. The material of the protective substrate 30 is not limited thereto, and a glass substrate, various ceramic substrates, a metal substrate such as a stainless substrate, or the like may be used.

In addition, the case member 40 that defines a part of the manifold 100 communicating with the plurality of pressure chambers 12 is fixed to the surface of the protective substrate 30 facing the −Z direction. The case member 40 has a substantially the same shape as the communication plate 15 when viewed in the Z-axis direction, and is bonded to the protective substrate 30 and is also bonded to the communication plate 15. Such a case member 40 includes a recessed portion 41 that is open to a surface facing the +Z direction and is deep enough to accommodate the pressure chamber substrate 10 and the protective substrate 30. The case member 40 has a third manifold portion 42 that communicates with the first manifold portion 17 of the communication plate 15. In addition, the manifold 100 of the present embodiment is configured with the first manifold portion 17 and the second manifold portion 18 provided in the communication plate 15 and the third manifold portion 42 provided in the case member 40. The manifold 100 is provided for each nozzle row. In other words, different types of ink can be ejected from each nozzle row. The case member 40 is provided with inlets 44 that communicate with the manifolds 100 and supply the ink to each of the manifolds 100. In addition, the case member 40 is provided with a coupling port 43 through which the wiring member 110 is inserted to communicate with the through-hole 32 of the protective substrate 30. The wiring member 110 is flowed out to the surface side of the liquid discharge head H facing the −Z direction, via the coupling port 43. As the case member 40, for example, a metal material, a resin material, or the like can be used.

In addition, a compliance substrate 45 is provided on the surface of the communication plate 15 facing the +Z direction on which the first manifold portion 17 and the second manifold portion 18 are open. The compliance substrate 45 seals the openings of the first manifold portion 17 and the second manifold portion 18 on the +Z direction side. In the present embodiment, the compliance substrate 45 includes a sealing film 46 made of a flexible thin film and a fixed substrate 47 made of a hard material such as metal. A region of the fixed substrate 47 facing the manifold 100 serves as a compliance opening portion 48 that is completely removed in the thickness direction, and one surface of the manifold 100 serves as a compliance portion 49 that is sealed only with the flexible sealing film 46.

In such a liquid discharge head H, the liquid is taken in from the inlet 44, and the inside of the flow path from the manifold 100 to the nozzle 21 is filled with the ink. After that, in accordance with a signal from the drive circuit 111, a voltage is applied to each active portion 310 corresponding to the pressure chamber 12, thereby deflecting and deforming the diaphragm 50 together with the piezoelectric actuator 300 such that the pressure chamber 12 side is convex as shown in FIG. 6. Thus, pressure of the liquid in the pressure chamber 12 increases, and droplets are ejected from a predetermined nozzle 21.

Here, when a voltage is applied to the active portions 310 of the piezoelectric actuator 300 to drive the piezoelectric actuator 300, the diaphragm 50 and the piezoelectric actuator 300 deform to be convex toward the pressure chamber 12 side as shown in FIG. 6. FIG. 6 is a view taken along a line V-V that schematically shows the deformation state of the piezoelectric actuator 300 and the diaphragm 50.

In addition, the diaphragm 50 of the present embodiment is provided in a region facing the pressure chambers 12, and has portions in which the diaphragm 50 not provided with the piezoelectric layer 70 is provided, so-called, arm portions 55, on both sides of the piezoelectric layer 70 in the X-axis direction in the region facing the pressure chamber 12. In the present embodiment, the arm portion 55 is provided with the diaphragm 50 and the second electrode 80. The arm portion 55 mainly deforms such that the pressure chamber 12 side becomes the curvature center rather than the diaphragm 50, and the active portion 310 in the arm portion 55 mainly deforms such that the opposite side to the pressure chamber 12 becomes the curvature center rather than the diaphragm 50.

Such a diaphragm 50 may be a single layer or may be a plurality of layers stacked. In addition, only the arm portions 55 of the diaphragm 50 may be configured as a single layer, and the other regions may be configured as a plurality of layers stacked. Between the arm portions 55 and regions other than the arm portions 55, that is, the active portions 310, the non-flexible portions, and the like, the stacked structure may be different, or the thickness of each film may be different.

In such a diaphragm 50, internal stress in at least the uppermost layer of the arm portion 55, that is, the layer positioned farthest in the −Z direction is a compressive stress. In addition, in the diaphragm 50, the sum of the internal stresses in the arm portion 55 is a compressive stress. In the diaphragm 50, the internal stress in the uppermost layer, that is, the layer positioned farthest in the −Z direction may be a tensile stress when the sum of the internal stresses in the layers above the center of the thickness of the diaphragm 50 is a compressive stress. In addition, in the diaphragm 50, the internal stress in the arm portions 55 and the other regions is preferably a compressive stress.

Such a diaphragm 50 is configured as a single layer or by stacking a plurality of layers. When the diaphragm 50 is configured as a single layer, the diaphragm 50 is made of a compressive stress film as the internal stress. Therefore, the internal stress in the uppermost layer of the arm portion 55 and the sum of the internal stresses are both compressive stress.

In addition, in a first case where the arm portions 55 and the other regions are configured as the same plurality of layers, the diaphragm 50 may have a configuration in which the uppermost layer and the other layers are tensile stress films when the sum of the internal stresses in the layers above the center of the thickness of the diaphragm 50 is a compressive stress. However, at least the sum of the internal stresses in the arm portions 55 is a compressive stress. In addition, it is more preferable that the internal stress in the uppermost layer is a compressive stress. In addition, it is more preferable that the diaphragm 50 has a configuration in which the internal stress in the uppermost layer is a compressive stress and the sum of the internal stresses in the layers above the center of the thickness of the diaphragm 50 is a compressive stress. It is still more preferable that all of the layers of the diaphragm 50 have a compressive stress.

The compressive stress refers to an internal stress generated in a first layer when the first layer is shortened by a second layer in a configuration in which the first layer that is the target and the second layer in contact with the first layer are provided. At this time, the first layer has a force that repels the force that comes from the second layer and compresses the first layer. On the other hand, the tensile stress refers to an internal stress generated in the first layer when the first layer is pulled by the second layer. At this time, the first layer has a force that repels the force that comes from the second layer and pulls the first layer.

The material of such a diaphragm 50 is not limited to silicon oxide, and examples thereof include simple substances, compounds, oxides, and nitrides containing one or more of silicon, zirconium, titanium, hafnium, lead, barium, potassium, sodium, niobium, aluminum, bismuth, and iron.

In the present embodiment, the diaphragm 50 is configured as a single layer of the elastic film 51 made of silicon oxide having a compressive stress as the internal stress. That is, the elastic film 51 of silicon oxide formed by thermally oxidizing the surface of the silicon substrate that is used as the pressure chamber substrate 10 has a compressive stress as the internal stress.

The internal stress also changes depending on a method for manufacturing the film that configures the diaphragm 50. For example, when a silicon substrate is used as the pressure chamber substrate 10, and the elastic film 51 is formed by thermally oxidizing the silicon substrate, the internal stress changes depending on the heating temperature at that time. A silicon oxide layer having a compressive stress as the internal stress can be formed by thermally oxidizing the silicon substrate. In addition, the magnitude of the compressive stress can be adjusted by the heating temperature.

When the diaphragm 50 has a layer made of zirconium oxide, the internal stress of the layer becomes a compressive stress by adjusting the thermal oxidation temperature. Similarly, when the diaphragm 50 has a layer made of titanium oxide, the internal stress of the layer becomes a compressive stress by adjusting the thermal oxidation temperature. A compressive stress can be given as the internal stress by the manufacturing method even in the case of other materials.

When the sum of the internal stresses in the arm portions 55 is made to be a compressive stress as described above, the directions of the forces become the same between a tensile stress as an external stress when the active portions 310 are driven and the compressive stress as the internal stress, and the diaphragm 50 can be thus efficiently deformed. In particular, the arm portion 55 deforms such that the curvature center is on the pressure chamber 12 side, and thus has a great influence on the amount of displacement of the diaphragm 50. On the other hand, for example, when the sum of the internal stresses in the arm portions 55 is a tensile stress, the directions of the forces are opposite between a tensile stress as an external stress due to the driving of the active portions 310 and the tensile stress as the internal stress, and the diaphragm 50 cannot be efficiently deformed. Therefore, when the drive voltage is increased, as a tensile force as an external stress increases, the diaphragm 50 tends to shrink but is forcibly extended, and the diaphragm 50 thus becomes harder as the diaphragm 50 is further deformed. Therefore, the amount of displacement of the diaphragm 50 when the ink is discharged is suppressed, and it becomes difficult for the ink to be discharged.

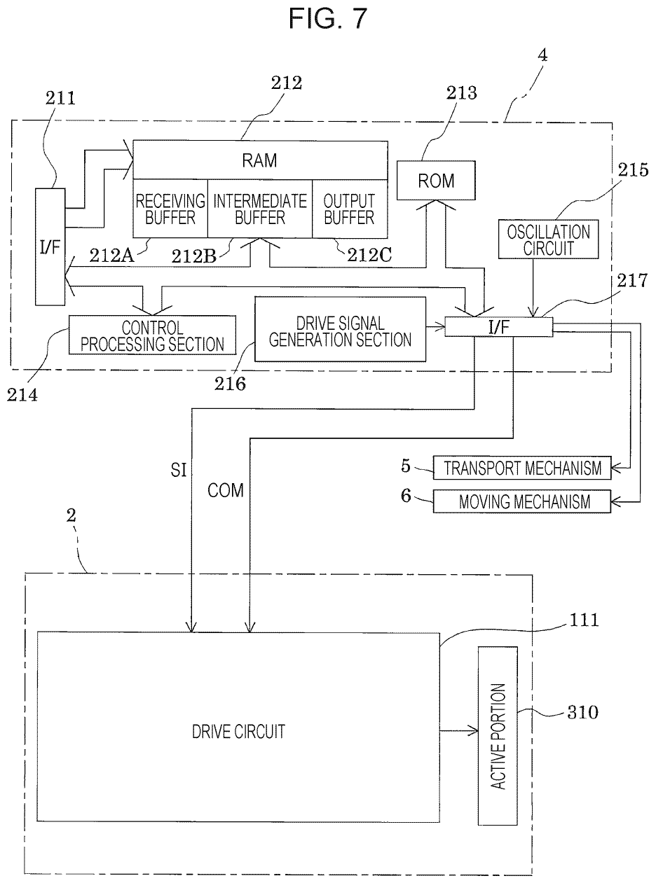

FIG. 7 is a block diagram showing the electrical configuration of the liquid discharge apparatus 1 according to Embodiment 1 of the present disclosure.

The control section 4 is an element that controls the entire liquid discharge apparatus 1. The control section 4 includes an external interface 211 (hereinafter referred to as the external I/F 211), a RAM 212 for temporarily storing various types of data, a ROM 213 for storing a control program and the like, a control processing section 214 including a CPU and the like, an oscillation circuit 215 for generating a clock signal (CK), a drive signal generation section 216 for generating a drive signal to be supplied to the liquid discharge head H, and an internal interface 217 (hereinafter referred to as the internal I/F 217).

The external I/F 211 is an interface for transmitting and receiving data to and from a host computer (not shown) or the like. The data received by the control section 4 from the host computer via the external I/F 211 includes, for example, print data configured with character codes, graphic functions, image data, and the like. Moreover, examples of data transmitted by the control section 4 via the external I/F 211 include a busy signal (BUSY) and an acknowledge signal (ACK). The RAM 212 functions as a receiving buffer 212A, an intermediate buffer 212B, an output buffer 212C, and a work memory (not shown). The receiving buffer 212A temporarily stores print data received by the external I/F 211, the intermediate buffer 212B stores intermediate code data converted by the control processing section 214, and the output buffer 212C stores dot pattern data. This dot pattern data is configured with recording data (SI) obtained by decoding (translating) the gradation data.

The drive signal generation section 216 generates a drive signal COM. The drive signal COM, which will be described in detail later, is a signal having a discharge pulse DP for driving the active portions 310 to discharge the droplets through the nozzles 21 within one unit period T, and is repeatedly generated every unit period T. This unit period T is the repeating unit of the drive signal COM, is a discharge period T, is also referred to as a recording period T, and corresponds to one pixel of an image to be printed on the medium S.

The ROM 213 stores font data, graphic functions, and the like in addition to a control program (control routine) for causing the control processing section 214 to perform various types of data processing. The control processing section 214 reads the print data in the receiving buffer 212A and stores intermediate code data obtained by converting the print data in the intermediate buffer 212B. Moreover, the intermediate code data read from the intermediate buffer 212B is analyzed, and the intermediate code data is expanded into recording data by referring to the font data and graphic functions stored in the ROM 213. Then, the control processing section 214 performs necessary decoration processing and then stores the expanded recording data in the output buffer 212C. The control program may be read from a recording medium such as a floppy disk, a CD-ROM, a DVD-ROM, or a USB memory that is directly coupled via the external I/F 211 or that is coupled via a host computer. The control program may also be provided in the host computer as a printer driver.

During printing, when the control processing section 214 obtains recording data equivalent to one line of the liquid discharge head H, the control processing section 214 outputs this one line of recording data to the liquid discharge head H through the internal I/F 217. Furthermore, when one line of recording data is output from the output buffer 212C, the expanded intermediate code data is erased from the intermediate buffer 212B, and the expansion processing is performed on the next intermediate code data.

The liquid discharge head H includes the drive circuit 111 as described above. The drive circuit 111 is a circuit that supplies a drive signal COM to the active portion 310 based on the recording data (SI) sent from the control section 4 via the internal I/F 217.

The recording data is configured with a plurality of pieces of pixel data to be discharged for each of a plurality of dots that constitute one line. For example, it is assumed that pixel data is binary, with “1” representing that a dot is to be formed and “0” representing that a dot is not to be formed. When the pixel data is “1”, the drive circuit 111 supplies the discharge pulse DP to the active portion 310 which discharges droplets through the nozzle 21 corresponding to the pixel data, and when the pixel data is “0”, the drive circuit 111 does not supply the discharge pulse DP to the active portion 310.

In this manner, under the control of the control section 4, the liquid discharge head H discharges droplets through each nozzle 21 at a timing defined by the recording data or the like. The control section 4 controls the transport mechanism 5 to transport the medium S and the moving mechanism 6 to reciprocate the liquid discharge head H via the internal I/F 217 in parallel with the discharge operation by the liquid discharge head H. Printing is performed on the medium S under such control of the control section 4.

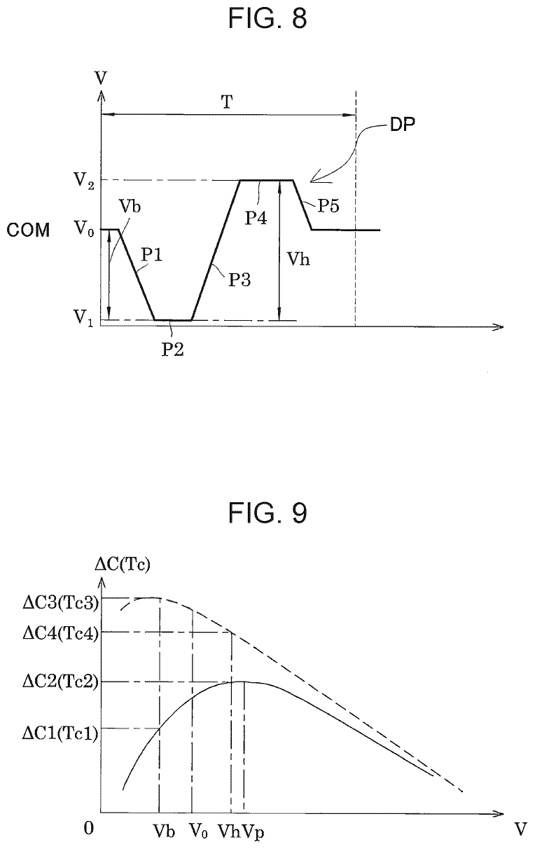

FIG. 8 is a drive waveform showing an example of the drive signal COM of the present embodiment.

As shown in FIG. 8, the drive signal COM is repeatedly generated from the drive signal generation section 216 for each unit period T defined by a clock signal transmitted from the oscillation circuit 215. The unit period T corresponds to one pixel of an image or the like to be printed on the medium S. In the present embodiment, the discharge pulse DP is generated in the unit period T.

In the present embodiment, the drive signal COM is supplied to the first electrode 60 that is an individual electrode by using the second electrode 80 that is a common electrode for the active portion 310 as a reference potential. That is, the voltage applied to the second electrode 80 by the drive signal COM is represented as a potential with the reference potential as a reference.

The discharge pulse DP of the drive signal COM continuously has an expansion element P1, an expansion maintaining element P2, a contraction element P3, a contraction maintaining element P4, and an expansion return element P5 in this order in time series.

The expansion element P1 changes the potential from an intermediate potential V₀ to a first potential V₁ to expand the volume of the pressure chamber 12 from the reference volume. Due to this expansion element P1, the liquid level of the liquid in the nozzle 21 is pulled toward the pressure chamber 12 side, and the liquid is supplied to the pressure chamber 12 from the manifold 100 side.

The expansion maintaining element P2 maintains the first potential V₁ for a certain period of time. During the supply of the expansion maintaining element P2, pressure vibration having a natural vibration period Tc occurs in the liquid in the pressure chamber 12.

The contraction element P3 changes the voltage from the first potential V₁ to a second potential V₂ to contract the volume of the pressure chamber 12 and discharge the droplets through the nozzle 21. The potential difference between the first potential V₁ and the second potential V₂ is a maximum voltage Vh of the discharge pulse DP. On the other hand, the potential difference from the intermediate potential V₀ of the expansion element P1 to the first potential V₁ is referred to as a minimum voltage Vb.

The contraction maintaining element P4 maintains the second potential V₂ for a certain period of time. Pressure vibration having the natural vibration period Tc occurs in the liquid in the pressure chamber 12 during the supply of the contraction maintaining element P4 to the active portion 310.

The expansion return element P5 changes the potential from the second potential V₂ to the intermediate potential V₀ to expand the volume of the pressure chamber 12. Due to this expansion return element P5, the pressure vibration of the liquid in the pressure chamber 12 is weakened. That is, the contraction maintaining element P4 and the expansion return element P5 function as so-called vibration damping elements that weaken the vibration of the ink in the nozzle 21 after the ink is discharged.

Here, the compliance ΔC of the piezoelectric actuator 300 will be described. The compliance ΔC of the piezoelectric actuator 300 is the physical quantity of the piezoelectric actuator 300 and the diaphragm 50 when the piezoelectric actuator 300 is viewed in the short hand direction, that is, in a cross-sectional view taken along the line V-V in FIG. 5, and indicates the softness and hardness of the piezoelectric actuator 300 and the diaphragm 50.

The compliance ΔC in the present embodiment refers to a component of the acoustic compliance. The acoustic compliance is expressed as a sum of a compliance caused by the compressibility of an acoustic medium and a compliance caused by the deformation of a structure surrounding the acoustic medium. When applied to the present embodiment, the acoustic medium corresponds to the ink or gas entering the pressure chamber 12, and the structure surrounding the acoustic medium corresponds to the diaphragm 50, the partition wall 11, and the like forming the pressure chamber 12. In addition, the latter compliance due to the deformation of the structure surrounding the acoustic medium is mainly caused by the deformation of the diaphragm 50 by the piezoelectric actuator 300.

In the present embodiment, the latter compliance due to the deformation of the structure surrounding the acoustic medium, that is, the compliance due to the deformation of the piezoelectric actuator 300 and the diaphragm 50 is used as the compliance ΔC. Hereinafter, the compliance ΔC of the piezoelectric actuator 300 will be simply referred to as the compliance ΔC.

The compliance ΔC has a correlation with the natural vibration period Tc of the pressure chamber 12 and the resonance frequency fa of the piezoelectric actuator 300 and the diaphragm 50 as shown in the following equation (1). Therefore, the compliance ΔC can be derived from the natural vibration period Tc or the resonance frequency fa. In addition, the compliance ΔC can also be measured by applying a pressure such as an air pressure.

$$fa ∝ \frac{1}{\sqrt{Δ C}} ∝ \frac{1}{Tc} \qquad ( 1 )$$

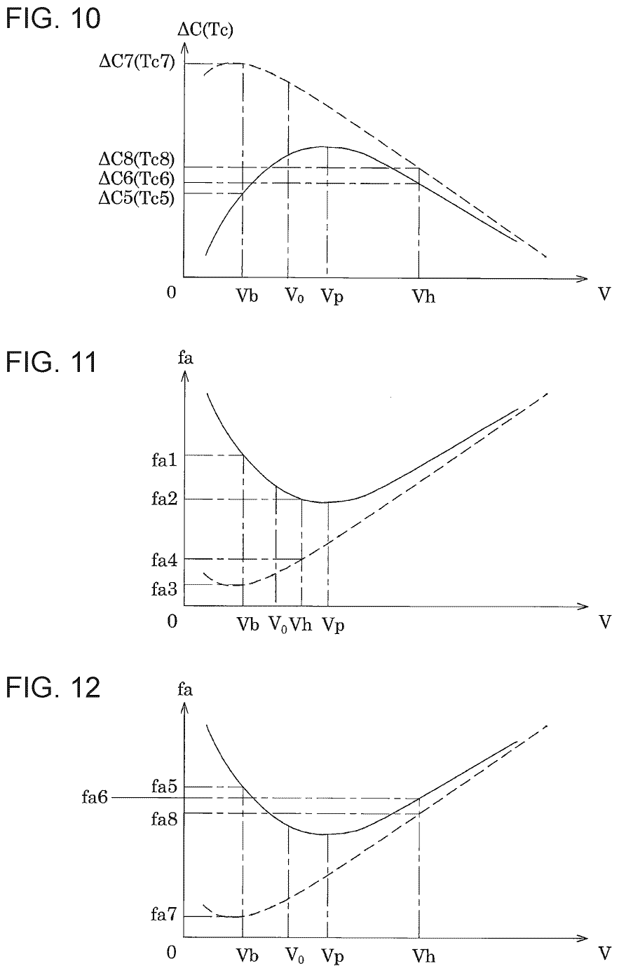

Here, the compliance-voltage curves are shown in FIG. 9 and FIG. 10. In FIG. 9 and FIG. 10, the compliance ΔC of the piezoelectric actuator 300 and the diaphragm 50 of the present embodiment, that is, the diaphragm 50 configured as a single layer of the elastic film 51 made of silicon oxide are shown by solid lines. In addition, as a comparative example, the compliance ΔC of the diaphragm 50 configured as a single layer of zirconium oxide having a tensile stress as the internal stress are shown by dotted lines. That is, even when the diaphragm 50 is configured by stacking a plurality of layers and the uppermost layer is a compressive stress film, the curve becomes substantially the same as the solid lines shown in FIG. 9 and FIG. 10, and even when the diaphragm 50 is configured by stacking a plurality of layers and the uppermost layer is a tensile stress film, the curve becomes substantially the same as the dotted lines shown in FIG. 9 and FIG. 10.

As shown in FIG. 9 and FIG. 10, the compliance ΔC-voltage curves of the present embodiment have a tendency that the compliance ΔC increases as the voltage increases, and the compliance ΔC decreases as the voltage increases from a certain voltage. The voltage at which the compliance ΔC is maximized is referred to as a peak voltage Vp.

Therefore, as shown in FIG. 9, the control section 4 controls so that the compliance value ΔC1 at the minimum voltage Vb of the drive signal COM becomes smaller than the compliance value ΔC2 at the maximum voltage Vh. In addition, as shown in FIG. 10, the control section 4 controls so that the compliance value ΔC5 at the minimum voltage Vb becomes smaller than the compliance value ΔC6 at the maximum voltage Vh. In FIG. 9, the minimum voltage Vb and the maximum voltage Vh are set not to interpose the peak voltage Vp. That is, the minimum voltage Vb and the maximum voltage Vh are determined in a range not exceeding the peak voltage Vp. In addition, in FIG. 10, the minimum voltage Vb and the maximum voltage Vh are set to interpose the peak voltage Vp.

On the other hand, as shown in FIG. 9 and FIG. 10, the compliance ΔC-voltage curve of the comparative example substantially declines steadily to the right, that is, has a tendency that the compliance ΔC decreases as the voltage increases. Therefore, as shown in FIG. 9, when driven at the same minimum voltage Vb and maximum voltage Vh as in the present embodiment, in the piezoelectric actuator and the diaphragm of the comparative example, the compliance value ΔC3 at the minimum voltage Vb becomes larger than the compliance value ΔC4 at the maximum voltage Vh. In addition, as shown in FIG. 10, when driven at the same minimum voltage Vb and maximum voltage Vh as in the present embodiment, the compliance value ΔC7 at the minimum voltage Vb becomes larger than the compliance value ΔC8 at the maximum voltage Vh.

When the compliance values ΔC2 and ΔC6 at the maximum voltage Vh at the time of contracting the pressure chamber 12 are relatively large by the contraction element P3 as in the present embodiment, the piezoelectric actuator 300 and the diaphragm 50 become soft when driven at the maximum voltage Vh. On the other hand, when the compliance values ΔC4 and ΔC8 at the maximum voltage Vh are relatively small as in the comparative example, the piezoelectric actuator 300 and the diaphragm 50 become hard when driven at the maximum voltage Vh. “Relatively large” or “relatively small” refers to the fact that the compliance value is relatively large or relatively small when compared with other compliance values in a range from the minimum voltage Vb to the maximum voltage Vh in each compliance ΔC-voltage curve.

Therefore, in the present embodiment, even when driven at the same maximum voltage Vh as in the comparative example, the amounts of deformation of the piezoelectric actuator 300 and the diaphragm 50 can be increased as compared with those in the comparative example, and the weight of the ink discharged through the nozzle 21 can be increased. Particularly, in the case of the comparative example, since the compliance values ΔC4 and ΔC8 at the maximum voltage Vh are relatively small, the piezoelectric actuator 300 and the diaphragm 50 driven by the contraction element P3 become hard, the amount of displacement decreases, and the weight of the ink discharged decreases. In addition, in the present embodiment, the maximum voltage Vh can be decreased in order to discharge ink droplets in the same ink weight as in the comparative example. The discharge period of the discharge pulse DP can also be shortened in this manner. In particular, when the minimum voltage Vb and the maximum voltage Vh are set to interpose the peak voltage Vp as shown in FIG. 10, the region in which the diaphragm 50 deforms to a larger extent is included, and a larger amount of displacement can be thus obtained even with the same maximum voltage Vh as in the comparative example.

In addition, when the compliance values ΔC1 and ΔC5 at the minimum voltage Vb at the time of expanding the pressure chamber 12 are relatively small by the expansion element P1 as in the present embodiment, the piezoelectric actuator 300 and the diaphragm 50 become hard when driven at the minimum voltage Vb. Therefore, the vibration of the meniscus in the nozzle 21 after the pressure chamber 12 is filled with the ink by the expansion element P1 of the present embodiment is rapidly attenuated, and the time of the expansion maintaining element P2 after the expansion element P1 can be thus shortened. Therefore, the time of the expansion maintaining element P2 is shortened, whereby the discharge period T of the discharge pulse DP can be shortened, and high-frequency driving can be performed.

In addition, as shown in FIG. 9, the compliance ΔC at the intermediate potential V₀ is larger than the compliance value ΔC1 at the minimum voltage Vb but is smaller than the compliance value ΔC2 at the maximum voltage Vh. Therefore, the hardness of the piezoelectric actuator 300 and the diaphragm 50 when the intermediate potential V₀ is applied thereto becomes harder by the expansion return element P5 than the hardness when driven at the maximum voltage Vh by the contraction element P3. Therefore, after the expansion return element P5 is supplied, the time for maintaining the intermediate potential V₀, that is, the time for damping the vibration in the pressure chamber 12 can be shortened. With this as well, the discharge period T of the discharge pulse DP can be shortened by supplying the discharge pulse DP and shortening the time taken until the next discharge pulse DP is supplied, and high-frequency driving can be performed.

In addition, as shown in FIG. 10, the compliance ΔC at the intermediate potential V₀ is larger than the compliance value ΔC5 at the minimum voltage Vb and the compliance value ΔC6 at the maximum voltage Vh. In the vicinity of the peak of the compliance ΔC, that is, in the vicinity of the peak voltage Vp, the internal stress approaches zero, and the diaphragm 50 is thus in a state of being subjected to no stress. Therefore, when the compliance ΔC at the intermediate potential V₀ is made to be larger than the compliance values ΔC5 and ΔC6, the intermediate potential V₀ can be brought closer to the peak voltage Vp, and breakage, such as cracking, can be made less likely to occur in the diaphragm 50 during the supply of the intermediate potential V₀.

In addition, when the minimum voltage Vb and the maximum voltage Vh are set to interpose the peak voltage Vp as shown in FIG. 10, the amount of change in the compliance ΔC at the minimum voltage Vb and the amount of change in the compliance ΔC at the maximum voltage Vh can be reduced, and the waveform design can be simplified to stabilize the discharge of the ink. That is, since the compliance ΔC is in a proportional relationship with the natural vibration period Tc, the amount of change in the natural vibration period Tc can be reduced at the minimum voltage Vb and the maximum voltage Vh, and the waveform design can be simplified to stabilize the discharge of the ink. That is, when the amounts of changes in the natural vibration period at the minimum voltage Vb and the natural vibration period at the maximum voltage are large, the waveform design such as the voltage, the time, and the slope, is difficult, and the discharge of the ink is not stable unless the waveform design is set correctly.

The natural vibration period Tc of the pressure chamber 12 of the present embodiment will be described. The natural vibration period Tc is a period of the pressure vibration of a liquid in a state where the pressure chamber 12 is filled with ink. Hereinafter, the natural vibration period Tc of the pressure chamber 12 will be simply referred to as the natural vibration period Tc.

Such a natural vibration period Tc can be acquired by, for example, detecting a residual vibration signal indicating a fluctuation in an electromotive force generated in the active portion 310 due to the vibration of the active portion 310 caused by the pressure vibration remaining in the liquid in the pressure chamber 12 after the active portion 310 is driven and analyzing the residual vibration signal. A method for acquiring the natural vibration period Tc is not particularly limited, and the natural vibration period Tc may be acquired by, for example, calculation, experiment, or the like.

Here, since the natural vibration period Tc is in a proportional relationship with the compliance ΔC of the piezoelectric actuator 300 and the diaphragm 50 as described above, the natural vibration period Tc-voltage curve becomes the same curve as the compliance ΔC-voltage curve shown in FIG. 9 and FIG. 10. Therefore, FIG. 9 and FIG. 10 show the compliance ΔC-voltage curves and the natural vibration period Tc-voltage curves. That is, similar to the above-described compliance ΔC, in FIG. 9 and FIG. 10, the natural vibration period Tc of the piezoelectric actuator 300 and the diaphragm 50 of the present embodiment, that is, the diaphragm 50 configured as a single layer of the elastic film 51 made of silicon oxide are shown by solid lines. In addition, as a comparative example, the natural vibration period Tc of the diaphragm 50 configured as a single layer of zirconium oxide having a tensile stress as the internal stress are shown by dotted lines.

As shown in FIG. 9 and FIG. 10, the natural vibration period Tc-voltage curve of the pressure chamber 12 of the present embodiment has a tendency that the natural vibration period Tc also increases as the voltage increases, and the natural vibration period Tc decreases as the voltage increases from a certain voltage. The voltage at which the natural vibration period Tc is maximized is referred to as the peak voltage Vp.

Therefore, as shown in FIG. 9, the control section 4 controls so that the natural vibration period value Tc1 at the minimum voltage Vb of the drive signal COM becomes smaller than the natural vibration period value Tc2 at the maximum voltage Vh. In addition, as shown in FIG. 10, the control section controls so that the natural vibration period value Tc5 at the minimum voltage Vb becomes smaller than the natural vibration period value Tc6 at the maximum voltage Vh. In FIG. 9, the minimum voltage Vb and the maximum voltage Vh are set not to interpose the peak voltage Vp. That is, the minimum voltage Vb and the maximum voltage Vh are determined in a range not exceeding the peak voltage Vp. In addition, in FIG. 10, the minimum voltage Vb and the maximum voltage Vh are set to interpose the peak voltage Vp.

On the other hand, as shown in FIG. 9 and FIG. 10, the natural vibration period Tc-voltage curve of the pressure chamber 12 in the comparative example substantially declines steadily to the right, that is, has a tendency that the natural vibration period Tc decreases as the voltage increases. Therefore, as shown in FIG. 9, when driven at the same minimum voltage Vb and maximum voltage Vh as in the present embodiment, in the piezoelectric actuator and the diaphragm of the comparative example, the natural vibration period value Tc3 at the minimum voltage Vb becomes larger than the natural vibration period value Tc4 at the maximum voltage Vh. In addition, as shown in FIG. 10, when driven at the same minimum voltage Vb and maximum voltage Vh as in the present embodiment, the natural vibration period value Tc7 at the minimum voltage Vb becomes larger than the natural vibration period value Tc8 at the maximum voltage Vh.

The fact that the natural vibration period values Tc2 and Tc6 at the maximum voltage Vh at the time of contracting the pressure chamber 12 are relatively large by the contraction element P3 as in the present embodiment indicates that the compliance ΔC is also large, and the piezoelectric actuator 300 and the diaphragm 50 become soft when driven at the maximum voltage Vh. On the other hand, the fact that the natural vibration period values Tc4 and Tc8 at the maximum voltage Vh are relatively small as in the comparative example indicates that the compliance ΔC is small, and the piezoelectric actuator 300 and the diaphragm 50 become hard when driven at the maximum voltage Vh. Therefore, in the present embodiment, even when driven at the same maximum voltage Vh as in the comparative example, the amounts of deformation of the piezoelectric actuator 300 and the diaphragm 50 can be increased as compared with those in the comparative example, and the weight of the ink discharged through the nozzle 21 can be increased. Particularly, in the case of the comparative example, since the natural vibration period values Tc4 and Tc8 at the maximum voltage Vh are relatively small, and the compliance ΔC is also relatively low, the piezoelectric actuator 300 and the diaphragm 50 driven by the contraction element P3 become hard, the amount of displacement decreases, and the weight of the ink discharged decreases. In addition, in the present embodiment, the maximum voltage Vh can be decreased in order to discharge ink droplets in the same ink weight as in the comparative example. The discharge period of the discharge pulse DP can also be shortened in this manner. In particular, when the minimum voltage Vb and the maximum voltage Vh are set to interpose the peak voltage Vp as shown in FIG. 10, the region in which the diaphragm 50 deforms to a larger extent is included, and a larger amount of displacement can be thus obtained even with the same maximum voltage Vh as in the comparative example.

In addition, since the natural vibration period values Tc1 and Tc5 at the minimum voltage Vb at the time of expanding the pressure chamber 12 are relatively small by the expansion element P1 as in the present embodiment, the vibration of the meniscus in the nozzle 21 after the pressure chamber 12 is filled with the ink by the expansion element P1 is rapidly attenuated. Therefore, the time of the expansion maintaining element P2 after the expansion element P1 can be shortened, and the discharge period T of the discharge pulse DP can be shortened, and high-frequency driving can be thus performed.

In addition, as shown in FIG. 9, the natural vibration period Tc at the intermediate potential V₀ is larger than the natural vibration period value Tc1 at the minimum voltage Vb and is smaller than the natural vibration period value Tc2 at the maximum voltage Vh. Therefore, after the expansion return element P5 is supplied, the time for maintaining the intermediate potential V₀, that is, the time for damping the vibration in the pressure chamber 12 can be shortened. With this as well, the discharge period T of the discharge pulse DP can be shortened by supplying the discharge pulse DP and shortening the time taken until the next discharge pulse DP is supplied, and high-frequency driving can be performed.

In addition, as shown in FIG. 10, the natural vibration period Tc at the intermediate potential V₀ is larger than the natural vibration period value Tc5 at the minimum voltage Vb and the natural vibration period value Tc6 at the maximum voltage Vh. The vicinity of the peak of the natural vibration period Tc, that is, the vicinity of the peak voltage Vp is the vicinity of the peak of the compliance ΔC, and the internal stress of the diaphragm 50 approaches zero, and the diaphragm 50 is thus in a state of being subjected to no stress. Therefore, when the natural vibration period Tc at the intermediate potential V₀ is made to be larger than the natural vibration period values Tc5 and Tc6, the intermediate potential V₀ can be brought closer to the peak voltage Vp, and breakage, such as cracking, can be made less likely to occur in the diaphragm 50 during the supply of the intermediate potential V₀.

In addition, when the minimum voltage Vb and the maximum voltage Vh are set to interpose the peak voltage Vp as shown in FIG. 10, the amount of change in the natural vibration period value Tc5 at the minimum voltage Vb and the amount of change in the natural vibration period value Tc6 at the maximum voltage Vh can be reduced, and the waveform design can be simplified to stabilize the discharge of the ink. That is, when the amounts of changes in the natural vibration period at the minimum voltage Vb and the natural vibration period at the maximum voltage are large, the waveform design such as the voltage, the time, and the slope, is difficult, and the discharge of the ink is not stable unless the waveform design is set correctly.

The resonance frequency fa of the piezoelectric actuator 300 of the present embodiment will be described. The resonance frequency fa is the resonance frequency of the piezoelectric actuator 300 and the diaphragm 50 when the pressure chamber 12 is not filled with the ink. Hereinafter, the resonance frequency fa of the piezoelectric actuator 300 will be simply referred to as the resonance frequency fa.

Such a resonance frequency fa can be measured by electrically resonating the piezoelectric actuator 300 and the diaphragm 50. That is, since impedance changes at the resonating timing, the resonance frequency can be measured from the movement of an electrical signal.

Here, resonance frequency-electrode curves are shown in FIG. 11 and FIG. 12. In FIG. 11 and FIG. 12, the resonance frequency fa of the piezoelectric actuator 300 and the diaphragm 50 of the present embodiment, that is, the diaphragm 50 configured as a single layer of the elastic film 51 made of silicon oxide are shown by solid lines. In addition, as a comparative example, the resonance frequency fa of the diaphragm 50 configured as a single layer of zirconium oxide having a tensile stress as the internal stress are shown by dotted lines. That is, even when the diaphragm 50 is configured by stacking a plurality of layers and the uppermost layer is a compressive stress film, the curve becomes substantially the same as the solid lines shown in FIG. 11 and FIG. 12, and even when the diaphragm 50 is configured by stacking a plurality of layers and the uppermost layer is a tensile stress film, the curve becomes substantially the same as the dotted lines shown in FIG. 11 and FIG. 12.

As shown in FIG. 11 and FIG. 12, the resonance frequency fa-voltage curves of the present embodiment have a tendency that the resonance frequency fa decreases as the voltage increases, and the resonance frequency fa increases as the voltage increases from a certain voltage. The voltage at which the resonance frequency fa is minimized is referred to as the peak voltage Vp.

Therefore, as shown in FIG. 11, the control section 4 controls so that the resonance frequency value fa1 at the minimum voltage Vb of the drive signal COM becomes higher than the resonance frequency value fa2 at the maximum voltage Vh. In addition, as shown in FIG. 12, the control section 4 controls so that the resonance frequency value fa5 at the minimum voltage Vb becomes higher than the resonance frequency value fa6 at the maximum voltage Vh. In FIG. 11, the minimum voltage Vb and the maximum voltage Vh are set not to interpose the peak voltage Vp. That is, the minimum voltage Vb and the maximum voltage Vh are determined in a range not exceeding the peak voltage Vp. In addition, in FIG. 12, the minimum voltage Vb and the maximum voltage Vh are set to interpose the peak voltage Vp.

On the other hand, as shown in FIG. 11 and FIG. 12, the resonance frequency fa-voltage curve of the comparative example substantially increases steadily to the right, that is, has a tendency that the resonance frequency fa increases as the voltage increases. Therefore, as shown in FIG. 11, when driven at the same minimum voltage Vb and maximum voltage Vh as in the present embodiment, in the piezoelectric actuator and the diaphragm of the comparative example, the resonance frequency value fa3 at the minimum voltage Vb becomes lower than the resonance frequency value fa4 at the maximum voltage Vh. In addition, as shown in FIG. 12, in the piezoelectric actuator and the diaphragm of the comparative example, when driven at the same minimum voltage Vb and maximum voltage Vh as in the present embodiment, the resonance frequency value fa7 at the minimum voltage Vb becomes lower than the resonance frequency value fa8 at the maximum voltage Vh.

The fact that the resonance frequency values fa2 and fa6 at the maximum voltage Vh at the time of contracting the pressure chamber 12 are relatively low by the contraction element P3 as in the present embodiment indicates that the inversely proportional compliance ΔC is large, and the piezoelectric actuator 300 and the diaphragm 50 become soft when driven at the maximum voltage Vh. On the other hand, the fact that the resonance frequency values fa4 and fa8 at the maximum voltage Vh are relatively high as in the comparative example indicates that the inversely proportional compliance ΔC is small, and the piezoelectric actuator 300 and the diaphragm 50 become hard when driven at the maximum voltage Vh. Therefore, in the present embodiment, even when driven at the same maximum voltage Vh as in the comparative example, the amounts of deformation of the piezoelectric actuator 300 and the diaphragm 50 can be increased as compared with those in the comparative example, and the weight of the ink discharged through the nozzle 21 can be increased. Particularly, in the case of the comparative example, since the resonance frequency values fa4 and fa8 at the maximum voltage Vh are low, and the compliance ΔC is large, the piezoelectric actuator 300 and the diaphragm 50 driven by the contraction element P3 become hard, the amount of displacement decreases, and the weight of the ink discharged decreases. In addition, in the present embodiment, the maximum voltage Vh can be decreased in order to discharge ink droplets in the same ink weight as in the comparative example. The discharge period of the discharge pulse DP can also be shortened in this manner. In particular, when the minimum voltage Vb and the maximum voltage Vh are set to interpose the peak voltage Vp as shown in FIG. 12, the region in which the diaphragm 50 deforms to a larger extent is included, and a larger amount of displacement can be thus obtained even with the same maximum voltage Vh as in the comparative example.

In addition, since the resonance frequency values fa1 and fa5 at the minimum voltage Vb at the time of expanding the pressure chamber 12 are relatively high by the expansion element P1 as in the present embodiment, the inversely proportional natural vibration period Tc becomes small, and the vibration of the meniscus in the nozzle 21 after the pressure chamber 12 is filled with the ink by the expansion element P1 is rapidly attenuated. Therefore, the time of the expansion maintaining element P2 after the expansion element P1 can be shortened, and the discharge period T of the discharge pulse DP can be shortened, and high-frequency driving can be thus performed.

In addition, as shown in FIG. 11, the resonance frequency fa at the intermediate potential V₀ is lower than the resonance frequency value fa1 at the minimum voltage Vb and is higher than the resonance frequency value fa2 at the maximum voltage Vh. Therefore, after the expansion return element P5 is supplied, the time for maintaining the intermediate potential V₀, that is, the time for damping the vibration in the pressure chamber 12 can be shortened. With this as well, the discharge period T of the discharge pulse DP can be shortened by supplying the discharge pulse DP and shortening the time taken until the next discharge pulse DP is supplied, and high-frequency driving can be performed.

In addition, as shown in FIG. 12, the resonance frequency fa at the intermediate potential V₀ is lower than the resonance frequency value fa5 at the minimum voltage Vb and the resonance frequency value fa6 at the maximum voltage Vh. The vicinity of the peak of the resonance frequency fa, that is, the vicinity of the peak voltage Vp is the vicinity of the peak of the compliance ΔC, and the internal stress of the diaphragm 50 approaches zero, and the diaphragm 50 is thus in a state of being subjected to no stress. Therefore, when the resonance frequency fa at the intermediate potential V₀ is made to be lower than the resonance frequency values fa5 and fa6, the intermediate potential V₀ can be brought closer to the peak voltage Vp, and breakage, such as cracking, can be made less likely to occur in the diaphragm 50 during the supply of the intermediate potential V₀.

In addition, when the minimum voltage Vb and the maximum voltage Vh are set to interpose the peak voltage Vp as shown in FIG. 12, the amount of change in the resonance frequency value fa5 at the minimum voltage Vb and the amount of change in the resonance frequency value fa8 at the maximum voltage Vh can be reduced, and the waveform design can be simplified to stabilize the discharge of the ink. That is, when the amounts of changes in the resonance frequency at the minimum voltage Vb and the resonance frequency at the maximum voltage are large, the amount of change in the natural vibration period Tc also becomes large, the waveform design such as the voltage, time, slope, or the like of the discharge pulse DP is difficult, and the discharge of the ink is not stable unless the waveform design is set correctly.

### Example 1

The configuration was as described in Embodiment 1, that is, the diaphragm 50 was configured as a single layer of a compressive stress film of silicon oxide in which a compressive stress was given as the internal stress.

### Example 2

The configuration was the same as described in Embodiment 1 except that the diaphragm 50 was configured by stacking two layers of a tensile stress film of zirconium oxide in which a tensile stress was given as the internal stress and a compressive stress film of silicon oxide in which a compressive stress was given as the internal stress, the uppermost layer was a compressive stress film, and a compressive stress was given as the internal stress in the arm portion 55 of the diaphragm 50.

### Comparative Example 1

The configuration was the same as described in Embodiment 1 except that the diaphragm was configured as a single layer of a tensile stress film of zirconium oxide in which a tensile stress was given as the internal stress.

### Comparative Example 2

The configuration was the same as described in Embodiment 1 except that the diaphragm was configured by stacking two layers of a compressive stress film of silicon oxide in which a compressive stress was given as the internal stress and a tensile stress film of zirconium oxide in which a tensile stress was given as the internal stress on the opposite side, the uppermost layer was a tensile stress film, and a tensile stress was given as the internal stress in the arm portion of the diaphragm.

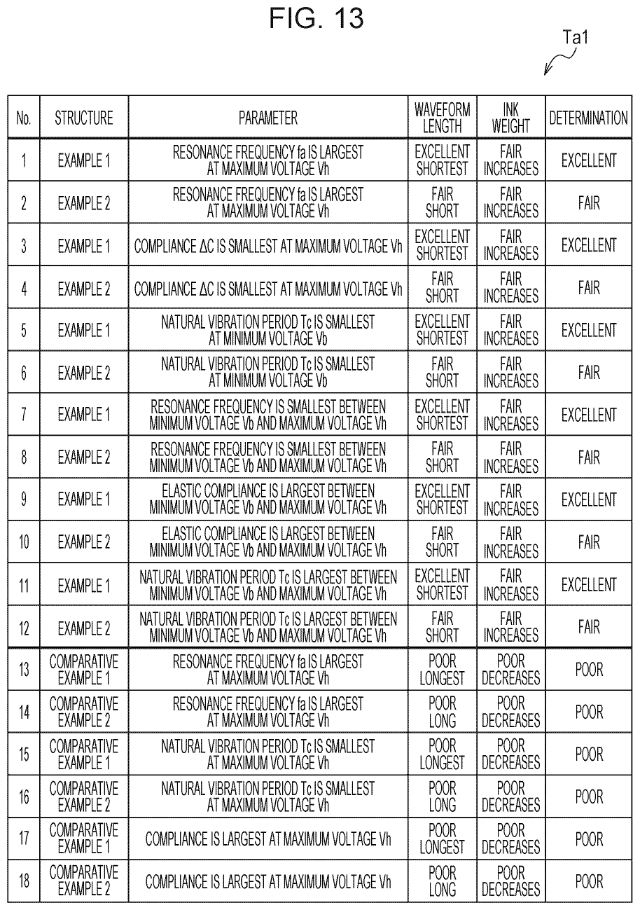

For Examples 1 and 2 and Comparative Examples 1 and 2, the combinations of the minimum voltage Vb and the maximum voltage Vh and the compliance ΔC, the natural vibration period Tc, and the resonance frequency fa, and the obtained effects and determinations are shown in Table Ta1 of FIG. 13. In Table Ta1, the case where the minimum voltage Vb and the maximum voltage Vh of FIG. 9 and FIG. 11 were used and the case where the minimum voltage Vb and the maximum voltage Vh of FIG. 10 and FIG. 12 were used are separated. In addition, in Table Ta1, the waveform length of the obtained effect refers to the waveform length of the discharge pulse DP when the same ink weight of the ink is discharged. In addition, the weight of the obtained effect refers to the weight of the ink discharged by the same discharge pulse DP.

As shown in Table Ta1, Nos. 1 to 6 are cases where the minimum voltage Vb and the maximum voltage Vh were set in a range not exceeding the peak voltage Vp, as shown in FIG. 9 and FIG. 11 described above. In addition, Nos. 7 to 12 are cases where the minimum voltage Vb and the maximum voltage Vh were set to interpose the peak voltage Vp as shown in FIG. 10 and FIG. 12 described above.

Since the compressive stress in the diaphragm 50 of Example 1 is larger than the compressive stress in the diaphragm 50 of Example 2, the waveform lengths can be made to be the shortest in Nos. 1, 3, 5, 7, 9, and 11.

In Example 2, the diaphragm 50 was configured with a tensile stress film of zirconium oxide and a compressive stress film of silicon oxide, but the configuration is not particularly limited thereto, and even when a tensile stress film made of titanium oxide in which the internal stress is a tensile stress is further provided between the tensile stress film of zirconium oxide and the compressive stress film of silicon oxide, the results become the same as in Example 2 of Table Ta1.

In addition, a single layer of a compressive stress film can also be formed only in the arm portion 55 by forming a tensile stress film on the pressure chamber substrate 10, then, removing the tensile stress film corresponding to the arm portion 55 by ion milling or the like, and then forming a compressive stress film. Even with such a configuration, the results become the same as in Example 1 of Table Ta1.

In addition, in Comparative Example 2, the diaphragm 50 was configured with a compressive stress film of silicon oxide and a tensile stress film of zirconium oxide, but the configuration is not particularly limited thereto, and even when a tensile stress film made of titanium oxide in which the internal stress is a tensile stress is further provided between the compressive stress film of silicon oxide and the tensile stress film of zirconium oxide, the results become the same as in Comparative Example 2 of Table Ta1.

### Other Embodiments

One embodiment of the present disclosure was described above, but the basic configuration of the present disclosure is not limited to the above.

In Embodiment 1 described above, the configuration in which the expansion element P1 to the expansion return element P5 are included as the discharge pulse DP of the drive signal COM was exemplified, but the configuration is not particularly limited thereto, and the discharge pulse DP may be a trapezoidal wave. That is, the discharge pulse DP may be a signal having the expansion element, the expansion maintaining element, and the contraction element in this order. In the case of such a trapezoidal wave, the minimum voltage Vb is the disclosed voltage of the expansion element, and the maximum voltage Vh is the voltage of the expansion maintaining element. Even with such a trapezoidal wave, similar to Embodiment 1 described above, when the control section 4 can increase the weight of the ink discharged by setting the minimum voltage Vb and the maximum voltage Vh, and high-frequency driving can be performed with a shortened the waveform length.

In addition, in Embodiment 1 described above, the liquid discharge apparatus 1 in which the liquid discharge head H is mounted on the holding body 6a and moves in the main scanning direction was exemplified, but the configuration is not particularly limited thereto, and, for example, the present disclosure can also be applied even to a so-called line printer with which printing is performed with the liquid discharge head H fixed only by moving the medium S in the sub-scanning direction.

Further, the present disclosure is intended to cover a wide range of liquid ejecting apparatuses equipped with liquid ejecting heads. Examples of the liquid ejecting head include recording heads such as various ink jet recording heads used in an image recording apparatus such as a printer, and coloring material ejecting heads used in the manufacture of color filters in liquid crystal displays and the like. Examples of the liquid ejecting head include an electrode material ejecting head used for forming an electrode in an organic EL display, a field emission display (FED), and the like, and a bioorganic substance ejecting head used for manufacturing a biochip. The present disclosure can also be applied to liquid ejecting apparatuses equipped with these liquid ejecting heads.

### Supplementary Notes

From the embodiments described above, for example, the following configurations can be understood.
A liquid discharge apparatus according to Aspect 1, which is a preferable aspect, is a liquid discharge apparatus including a pressure chamber substrate provided with a pressure chamber communicating with a nozzle through which liquid is discharged, a diaphragm provided on the pressure chamber substrate, a piezoelectric element provided on the diaphragm and having a piezoelectric layer interposed between two electrodes, and a control section that controls driving of the piezoelectric element, the piezoelectric element being driven by the control section to apply a pressure to liquid in the pressure chamber to discharge the liquid through the nozzle, in which between a minimum voltage and a maximum voltage that are applied to the piezoelectric element by the control section, a compliance value of the piezoelectric element at the minimum voltage is smaller than a compliance value of the piezoelectric element at the maximum voltage. According to this, when driven at the maximum voltage, since the piezoelectric element and the diaphragm become soft, the amounts of deformation of the piezoelectric element and the diaphragm when driven at the maximum voltage can be increased, and the weight of droplets discharged can be increased. In addition, when driven at the minimum voltage, since the piezoelectric element and the diaphragm become hard, the vibration of the meniscus in the nozzle after the droplets are discharged is rapidly attenuated. Therefore, the damping time can be shortened, and high-frequency driving can be performed by shortening the waveform length.
In Aspect 2 which is a specific example of Aspect 1, the minimum voltage and the maximum voltage are set to interpose a peak voltage at which a value on a compliance-voltage curve of the piezoelectric element becomes a maximum value.
According to this, the amounts of changes in the compliance at the minimum voltage and the compliance at the maximum voltage can be reduced, the waveform design such as the voltage, the time, and the slope can be simplified, and the discharge of the liquid can be stabilized.
In Aspect 3 which is a specific example of Aspect 2, a compliance value of the piezoelectric element at an intermediate potential applied to the piezoelectric element is larger than the compliance value of the piezoelectric element at the minimum voltage and the compliance value of the piezoelectric element at the maximum voltage. According to this, the compliance at the intermediate potential can be brought close to the vicinity of the maximum compliance, the stress applied to the diaphragm is reduced, and breakage, such as cracking, is less likely to occur in the diaphragm.
A liquid discharge apparatus according to Aspect 4, which is a preferable aspect, is a liquid discharge apparatus including a pressure chamber substrate provided with a pressure chamber communicating with a nozzle through which liquid is discharged, a diaphragm provided on the pressure chamber substrate, a piezoelectric element provided on the diaphragm and having a piezoelectric layer interposed between two electrodes, and a control section that controls driving of the piezoelectric element, the piezoelectric element being driven by the control section to apply a pressure to liquid in the pressure chamber to discharge the liquid through the nozzle, in which between a minimum voltage and a maximum voltage that are applied to the piezoelectric element by the control section, a natural vibration period of the pressure chamber at the minimum voltage is smaller than a natural vibration period of the pressure chamber at the maximum voltage. According to this, since the natural vibration period is proportional to the compliance, the natural vibration period being large when driven at the maximum voltage means the piezoelectric element and the diaphragm being soft, and the amounts of deformation of the piezoelectric element and the diaphragm when driven at the maximum voltage can be thus increased, and the weight of droplets discharged can be increased. In addition, the natural vibration period being small when driven at the minimum voltage means the piezoelectric element and the diaphragm being hard, and the vibration of the meniscus in the nozzle after the droplets are discharged is rapidly attenuated. Therefore, the damping time can be shortened, and high-frequency driving can be performed by shortening the waveform length.
In Aspect 5 which is a specific example of Aspect 4, the minimum voltage and the maximum voltage are set to interpose a peak voltage at which a value on a natural vibration period-voltage curve is maximized. According to this, the amounts of changes in the natural vibration period at the minimum voltage and the natural vibration period at the maximum voltage can be reduced, the waveform design such as the voltage, the time, and the slope can be simplified, and the discharge of the liquid can be stabilized.
In Aspect 6 which is a specific example of Aspect 5, a natural vibration period of the pressure chamber at an intermediate potential applied to the piezoelectric element is larger than the natural vibration period of the pressure chamber at the minimum voltage and the natural vibration period of the pressure chamber at the maximum voltage. According to this, the natural vibration period at the intermediate potential can be brought close to the vicinity of the maximum natural vibration period, the stress applied to the diaphragm is reduced, and breakage, such as cracking, is less likely to occur in the diaphragm.
A liquid discharge apparatus according to Aspect 7, which is a preferable aspect, is a liquid discharge apparatus including a pressure chamber substrate provided with a pressure chamber communicating with a nozzle through which liquid is discharged, a diaphragm provided on the pressure chamber substrate, a piezoelectric element provided on the diaphragm and having a piezoelectric layer interposed between two electrodes, and a control section that controls driving of the piezoelectric element, the piezoelectric element being driven by the control section to apply a pressure to liquid in the pressure chamber to discharge the liquid through the nozzle, in which between a minimum voltage and a maximum voltage that are applied to the piezoelectric element, a resonance frequency of the piezoelectric element at the minimum voltage is higher than a resonance frequency of the piezoelectric element at the maximum voltage. According to this, since the resonance frequency is inversely proportional to the compliance, the resonance frequency being low when driven at the maximum voltage means the piezoelectric element and the diaphragm being soft, and the amounts of deformation of the piezoelectric element and the diaphragm when driven at the maximum voltage can be thus increased, and the weight of droplets discharged can be increased. In addition, the resonance frequency being high when driven at the minimum voltage means the piezoelectric element and the diaphragm being hard, and the vibration of the meniscus in the nozzle after the droplets are discharged is rapidly attenuated. Therefore, the damping time can be shortened, and high-frequency driving can be performed by shortening the waveform length.
In Aspect 8 which is a specific example of Aspect 7, the minimum voltage and the maximum voltage are set to interpose a peak voltage at which a value on a resonance frequency-voltage curve of the piezoelectric element becomes a minimum value. According to this, the amounts of changes in the resonance frequency at the minimum voltage and the resonance frequency at the maximum voltage can be reduced, the waveform design such as the voltage, the time, and the slope can be simplified, and the discharge of the liquid can be stabilized.
In Aspect 9 which is a specific example of Aspect 8, a resonance frequency of the piezoelectric element at an intermediate potential applied to the piezoelectric element is lower than the resonance frequency of the piezoelectric element at the minimum voltage and the resonance frequency of the piezoelectric element at the maximum voltage. According to this, the resonance frequency at the intermediate potential can be brought close to the vicinity of the minimum resonance frequency, the stress applied to the diaphragm is reduced, and breakage, such as cracking, is less likely to occur in the diaphragm.

What is claimed is:

1. A liquid discharge apparatus comprising:
a pressure chamber substrate provided with a pressure chamber communicating with a nozzle through which liquid is discharged;
a diaphragm provided on the pressure chamber substrate;
a piezoelectric element provided on the diaphragm and having a piezoelectric layer interposed between two electrodes; and
a control section that controls driving of the piezoelectric element,
the piezoelectric element being driven by the control section to apply a pressure to liquid in the pressure chamber to discharge the liquid through the nozzle, wherein
a compliance value of the piezoelectric element at a minimum voltage which is applied to the piezoelectric element is smaller than a compliance value of the piezoelectric element at a maximum voltage which is applied to the piezoelectric element.

2. The liquid discharge apparatus according to claim 1, wherein
the minimum voltage and the maximum voltage are set to interpose a peak voltage at which a value on a compliance-voltage curve of the piezoelectric element becomes a maximum value.

3. The liquid discharge apparatus according to claim 2, wherein
a compliance value of the piezoelectric element at an intermediate potential applied to the piezoelectric element is larger than the compliance value of the piezoelectric element at the minimum voltage and the compliance value of the piezoelectric element at the maximum voltage.

4. A liquid discharge apparatus comprising:
a pressure chamber substrate provided with a pressure chamber communicating with a nozzle through which liquid is discharged;
a diaphragm provided on the pressure chamber substrate;
a piezoelectric element provided on the diaphragm and having a piezoelectric layer interposed between two electrodes; and
a control section that controls driving of the piezoelectric element,
the piezoelectric element being driven by the control section to apply a pressure to liquid in the pressure chamber to discharge the liquid through the nozzle, wherein
a natural vibration period of the pressure chamber at a minimum voltage which is applied to the piezoelectric element is smaller than a natural vibration period of the pressure chamber at a maximum voltage which is applied to the piezoelectric element.

5. The liquid discharge apparatus according to claim 4, wherein
the minimum voltage and the maximum voltage are set to interpose a peak voltage at which a value on a natural vibration period-voltage curve is maximized.

6. The liquid discharge apparatus according to claim 5, wherein
a natural vibration period of the pressure chamber at an intermediate potential applied to the piezoelectric element is larger than the natural vibration period of the pressure chamber at the minimum voltage and the natural vibration period of the pressure chamber at the maximum voltage.

7. A liquid discharge apparatus comprising:
a pressure chamber substrate provided with a pressure chamber communicating with a nozzle through which liquid is discharged;
a diaphragm provided on the pressure chamber substrate;
a piezoelectric element provided on the diaphragm and having a piezoelectric layer interposed between two electrodes; and
a control section that controls driving of the piezoelectric element,
the piezoelectric element being driven by the control section to apply a pressure to liquid in the pressure chamber to discharge the liquid through the nozzle, wherein
a resonance frequency of the piezoelectric element at a minimum voltage which is applied to the piezoelectric element is higher than a resonance frequency of the piezoelectric element at a maximum voltage which is applied to the piezoelectric element.

8. The liquid discharge apparatus according to claim 7, wherein
the minimum voltage and the maximum voltage are set to interpose a peak voltage at which a value on a resonance frequency-voltage curve of the piezoelectric element becomes a minimum value.

9. The liquid discharge apparatus according to claim 8, wherein
a resonance frequency of the piezoelectric element at an intermediate potential applied to the piezoelectric element is lower than the resonance frequency of the piezoelectric element at the minimum voltage and the resonance frequency of the piezoelectric element at the maximum voltage.
